(19) United States
(12) Patent Application Publication
(10) Pub. No.: US 2008/0104655 A1
(43) Pub. Date: May 1, 2008

(54) Digital Video Recorder Having a Pause Feature Displaying the First Frame of a Program

(75) Inventor: Colin D. Hayward, Newton, MA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/554,649

(22) Filed: Oct. 31, 2006

(51) Int. Cl. H04N 7/173; G06F 13/00; H04N 5/445; G06F 3/00

(52) U.S. Cl. 725/132; 725/37; 725/100; 725/89

(57) ABSTRACT

A method and apparatus is provided for rendering a frame or image of a selected video program. The method begins by receiving a single user command specifying an operational mode of a video rendering device that displays and pauses a first frame or image of the program. A control signal is generated in response to the received user command. The first frame or image of the program is displayed and paused in response to the control signal.

### FIELD OF THE INVENTION

The present invention relates generally to recording devices employed in a communications system and more specifically to a method and apparatus for scheduling and recording programs broadcast over a broadband communications system.

### BACKGROUND OF THE INVENTION

A conventional system for displaying a program, e.g., a video program, includes a monitor or a television (TV) set connected to a set top box or terminal. The set top box is connected through a coaxial cable to a cable TV network or a satellite dish for “satellite TV.” The TV set and the set top box are located, for example, in a user's home and receive a multitude of TV channels from a broadcast head end, wherein each TV channel has many programs available during a typical day. Instead of a set top box, the user may download and record programming over a communications network such as the Internet using, for example, a PC equipped with a network interface. In order to select and watch a certain program, the user controls the set top box (or PC) to tune to a desired channel. The set top box directs the video signal to the TV set, which then displays the program.

A user may expand the system by connecting a digital video recorder (DVR) to the TV set and the set top box to personalize television viewing by recording a program on the recorder and watching it when it is convenient for the user. DVRs may be implemented as stand alone devices that are interconnected to other devices. Alternatively, they may be implemented as a subsystem of a set top terminal, media center or television. In this case the DVR can control the channel tuned on the television, provide an interactive electronic program guide, and record programming on a manual or timer controlled basis. Additionally, the DVR can buffer incoming audiovisual programming to enable a viewer to pause or replay a portion of a live television program, so long as the pause or replay does not exceed the capacity of the buffer. In addition to the standard play mode (forward direction, standard speed), DVRs are capable of displaying video in several “trick play” modes. Trick play modes include fast forward play, slow forward play, fast reverse play, slow reverse play, and pause. Unfortunately, the user interface, which is typically a remote control, sometimes makes it difficult or awkward to implement these trick play modes.

### BRIEF DESCRIPTION OF THE DRAWINGS

FIG. 1 depicts the main components of a DVR system constructed in accordance with the principles of the present invention.

FIG. 2 depicts a DVR remote control for controlling the DVR system shown in FIG. 1.

FIG. 3 shows a simplified schematic drawing of one example of the remote control shown in FIG. 2.

FIG. 4 is a flowchart illustrating a method for displaying and pausing the first frame or image of a program that is stored on the storage medium of a DVR system.

### DETAILED DESCRIPTION

As detailed below, a user interface such as a remote control is provided for a video rendering device such as a DVR. The user interface includes a user-actuatable input (e.g., a button or key) for easily and conveniently displaying and pausing a first frame or image of a program to be rendered by the video rendering device.

It should be understood by those skilled in the art that, although the invention is described as implemented in connection with a DVR subsystem of a set-top terminal, the invention also may be implemented for use in a stand alone DVR device. In addition, those skilled in the art will realize that the invention may be implemented in connection with other types of video rendering devices including personal video recorders, video cassette recorders, DVD players and the like. The video rendering device also may be implemented as a stand-alone portable device or it may be incorporated in other devices, both portable and non-portable, such as a television, personal computer, PDA, and the like.

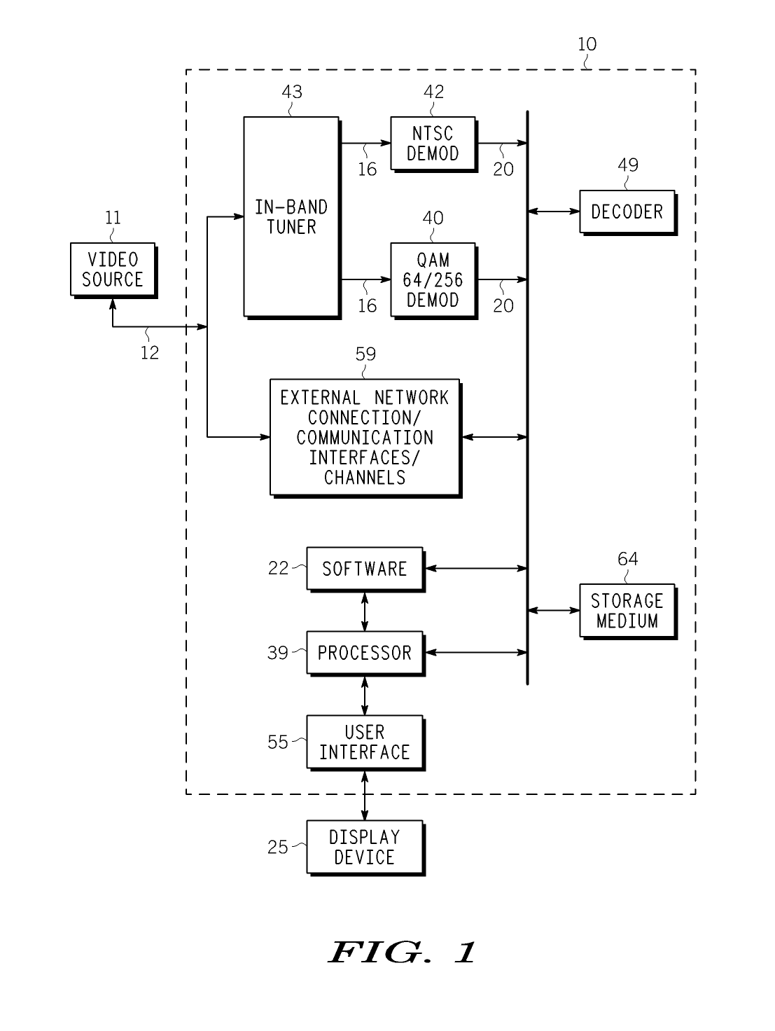

Turning now to the drawings, where like numerals designate like components, FIG. 1 is a block diagram of a DVR system 10 (“system 10”). System 10 receives video signal 12 from video source 11. As shown, DVR system 10 is a DVR-enabled cable set-top box, video source 11 is a hybrid fiber-optic/coax cable network operated by a cable television operator, and video signal 12 is a multi-channel analog and/or digital programming source broadcast by the cable operator. DVR system 10, however, may be any device or combination of devices capable of receiving, recording and playing back video signal 12; video source 11 may be any public or private, wired or wireless, video transmission infrastructure or technology, including but not limited to a fiber-optic network, a coaxial cable network, a hybrid network, a satellite network, cellular network, the Internet, a television network, a radio network, a copper wire network, or any other existing or future transmission infrastructure or technology, operated by any type of program provider, such as a television network or station, a studio, an Internet broadcaster or service provider, a cable operator, or a satellite operator; and video signal 12 may be any pre-recorded or live analog or digital electronic signal representing an image, audio and/or data, in any format.

DVR system 10 includes external network connection/communication interfaces 59, which support devices such as modems, streaming media players and other network connection support devices and/or software, coupled through local or wide area networks (not shown) to program providers and providers of other content, such as advertising content. DVR system 10 further includes an in-band tuner 43, which tunes to a channel signal 16 selected by a viewer via user interface 55. User interface 55 may be any type of known or future device or technology allowing the consumer to select channels or programs the consumer wishes to receive, such as a remote control, mouse, microphone, keyboard, or touch-screen display associated with a personal video recorder.

Channel signal 16 includes video and/or audio components that are received by demodulators 40 and 42. Demodulators 40 and 42 are responsive to in-band tuner 43. Demodulator 40, which may be a 64/256 quadrature amplitude modulation demodulator, for example, is responsive to receive a digital version of channel signal 16. Demodulator 40 identifies digital data packets from one or more digital sources, such as a Moving Pictures Experts'Group (MPEG) transport stream, a high-definition television stream, a quadrature amplitude modulated stream, or a media stream from an external network connection 59, such as a cable modem, using well-known methods and techniques. Demodulator 42, which may be an NTSC demodulator, for example, is responsive to receive an analog version of channel signal 16 and to decode signals and markers according to well-known methods and techniques. Demodulators 40 and 42 are operative to output video information 20.

Video information 20 includes raw video or audio data, arranged for formatting in accordance with a predetermined media format. Video information 20 is preferably arranged in accordance with an MPEG media format, such as an MPEG-2 media format, but may be arranged in accordance with other media formats, including but not limited to other MPEG formats, Hypertext Markup Language (HTML), Virtual Hypertext Markup Language (VHTML), X markup language (XML), H.261, H.263, or H.264 formats.

Storage medium 64 is responsive to receive, among other things, encoded video signal 20 for storage. Storage medium 64 may be any local or remote device, now known or later developed, capable of recording data, including but not limited to a hard disk drive, a videocassette recorder tape, all types of optical storage media such as compact disks and digital videodisks, a magnetic tape, a home router, or a server.

Decoder 49 is responsive to receive recorded encoded video signal 20 from storage medium 64, and to play back recorded encoded video signal 20 via display device 25, in response to instructions from user interface 55. Decoder 49 is also responsive to receive and pass through video programming directly from tuner 43. Internal arrangements of decoder 49 are well known—decoder 49 may include analog-to-digital converters, one or more storage media and/or buffers, and general or special-purpose processors or application-specific integrated circuits, along with demultiplexors for demultiplexing and/or synchronizing at least two transport streams, for example, video and audio. Video and audio decoders and/or analog and digital decoders may be separate, with communication between separate decoders allowing for synchronization, error correction and control.

Display device 25, which also includes speakers for outputting audio signals, displays video programming received from tuner 43 or storage medium 64. Display device 25 is responsive to receive analog or digital signals, including but not limited to S-video, composite audio-video, SPDIF, and DVI.

Processor 39 and software 22 are illustrated functionally, and are responsive to various elements of DVR system 10, including demodulators 40 and 42, storage medium 64 and decoder 49. When loaded into a processor, such as processor 39, software 22 is operative to control encoding, recording and playback of encoded video signal 20. It will be appreciated, however, that aspects of the present invention are not limited to any specific embodiments of computer software or signal processing methods. For example, one or more processors packaged together or with other elements of DVR system 10 may implement functions of processor 39 in a variety of ways. It will also be appreciated that software 22 may be any stored instructions, in one or more parts (stored, for example, on storage medium 64, or another internal or external storage medium such as a read-only-memory or a random-access memory) electronically controlling functions provided by DVR system 10, including firmware, and may be used or implemented by one or more elements, including one or more processors, of DVR system 10.

During normal operation of DVR system 10 in accordance with aspects of the present invention, a viewer using user interface 55 selects a particular program to be recorded from video source 11 and/or selects a recorded program for playback from storage medium 64. When a program is to be recorded, an encoded video signal 20 associated with the selected program is transferred to storage medium 64. Likewise, when a program is to be played back, an encoded video signal 20 associated with the selected program is transferred from storage medium 64 to decoder 49 for processing. Decoder 49 demultiplexes and decodes encoded video signal 20 for presentation to the consumer via display device 25.

As previously mentioned, in addition to a standard mode of operation, a video rendering device such as the previously described DVR system 10 can also operate in a number of “trick play” modes. In one trick play mode of operation, DVR system 10 can, via user interface 55, pause a program being played back via the user interface 55. For instance, a user interface such as a remote control may have a dedicated key or button that pauses the currently playing program. In a pause mode of operation, the DVR continuously displays a single frame or image of the program for some predetermined period of time or until the viewer deactivates the pause feature.

One problem with the use of the pause feature arises when the viewer wishes to pause the first frame or image of the program. Generally, before a pause function can be initiated by the viewer, the viewer first employs the user interface to activate the play function (e.g., by depressing a dedicated “play” key or button on a remote control) to begin playback of the program. That is, to invoke the pause feature, the viewer is required to activate two functions sequentially: the play function followed by the pause function. Unfortunately, this sequence of operations is problematic when the viewer wishes to pause the first frame or image of the program. At least two factors contribute to this problem. First, the viewer often will not have a sufficiently fast reaction time to reduce the time interval between when the play function is activated and when the pause function is activated so that the first frame or image is displayed and paused. Instead, as a result of the time delay, a subsequent frame or image of the program will be displayed. Even worse, the viewer may attempt to achieve this desired result by activating a sequence of three functions: play, rewind (to return to the first frame or image) and pause. Once again, the viewer's reaction time can prevent the viewer from pausing the first frame or image of the program.

A second factor that contributes to the viewer's difficulty in pausing the first frame or image of the program arises from the inherent latency in the system that occurs when it receives multiple inputs. This latency exists because a finite amount of time is required between the time a viewer initiates a function (e.g., play) and the time when the viewer is provided with feedback indicating that the function has been activated (e.g., by displaying the program on the display).

The aforementioned problems and limitations can be overcome by providing a user interface that can display and pause the first frame or image with a single input command. For instance, the user interface may be provided with a key or button that is dedicated to displaying and pausing the first frame or image. In this way the viewer is required to activate a single function instead of the sequence of two or even three functions that a conventional user interface requires to achieve this result.

In one example, instead of using a dedicated key or button to display and pause the first frame or image, a key or button that is already present on the DVR interface may be employed for this purpose. For instance, the “pause” key or button may be used for this dual purpose. Conventionally, the pause key or button can sometimes only be activated after the play function has been activated. However, in the present example, the pause button may serve a second purpose that is operational when the play function is inactive and inoperative when the play function is active. In this mode of operation, activation of the pause function (e.g., by depressing the pause key) without prior activation of the play function causes the first frame or image to be displayed and paused. On the other hand, if the play function is first activated, subsequent activation of the pause function will serve to pause the frame or image that is currently being displayed on the display device.

The user interface described above may be directly located on the video rendering device. For instance, keys or buttons may be directly located on the video rendering device. Alternatively, instead of buttons or keys, the video rendering device may present a menu of user selectable inputs on the display device. The inputs may be selected using an appropriate means associated with the user interface, such as a mouse, pointer, or a touch-screen incorporated into the display device.

In some cases the user interface is a remote control that is provided for convenient remote operation of the DVR system 10. FIG. 2 depicts a DVR remote control 200 that includes a number of buttons or keys for controlling the DVR system 10. These buttons may include, but are not limited to, the following:

| Keys | Function |
|---|---|
| Numeric keys 0 to 9 | Enter numerical data such as channel |
| | numbers, etc. (201) |
| MENU | Display on-screen menu (202) |
| Up, Down, Left, Right, Select | Select menu buttons (203) |
| Set-up | Set player parameters e.g. language, audio |
| | and display aspect ratio (204) |
| Play | Control playing of video (206) |
| Pause | Control playing of video (207) |
| Skip, Stop, | Control playing of video (205) |
| Fast reverse, Fast forward | Control playing of video (208) |
| Slow reverse, Fast reverse | Control playing of video (209) |
| Title | Title selection where there is more than |
| | one title |

In addition to the functions described above, the remote control 200 may also communicate with the display device 25 using conventional techniques to adjust, for example, the volume of the display device, the displayed channel, and the like.

Those skilled in the art will recognize that the various keys or buttons of the remote control 200 may differ depending on the particulars of the video rendering device that is employed. That is, different keys may be employed if the remote control is configured to operate with a DVR-enabled set-top terminal, a stand-alone DVR, a DVD player and the like. Moreover, the different keys or buttons can be positioned in different locations for purposes of ergonomics and ease-of-use.

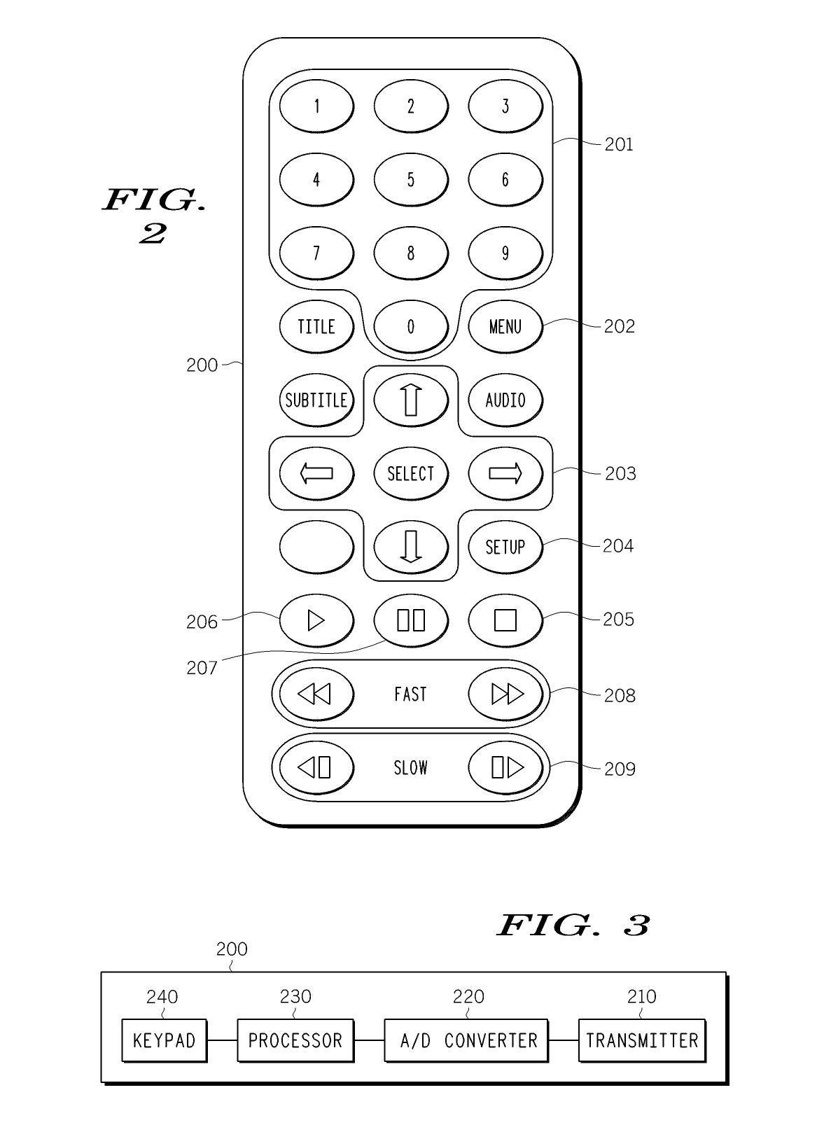

FIG. 3 shows a simplified schematic drawing of one example of the remote control 200. The remote control 200 includes conventional components such as a radio frequency (RF) transmitter 210. Alternatively, the transmitter 210 may be configured to transmit using infrared (IR), microwave, VHF, UHF, or other frequencies along the electromagnetic spectrum. The transmitter 210 may include an integrated RF antenna (linear or otherwise configured) etched onto the main printed circuit board of the remote. Integration of the antenna with the remote control's circuit board provides for compactness and efficiency in manufacture.

In some embodiments, the transmitter 210 is configured to broadcast digital signals. As such, the transmitter 210 may include an analog-to-digital converter (ADC) 220 to convert analog video/audio signals into digital information. However, the remote control 200 may use analog, digital or both types of transmissions.

The remote control 200 also includes a processor 230 in electrical communication with the transmitter 210 and keypad 240. The processor 210 senses a user's operation of the buttons of the remote control and generates appropriate command signals for transmission to the DVR system 10 in order to control the operation of the same.

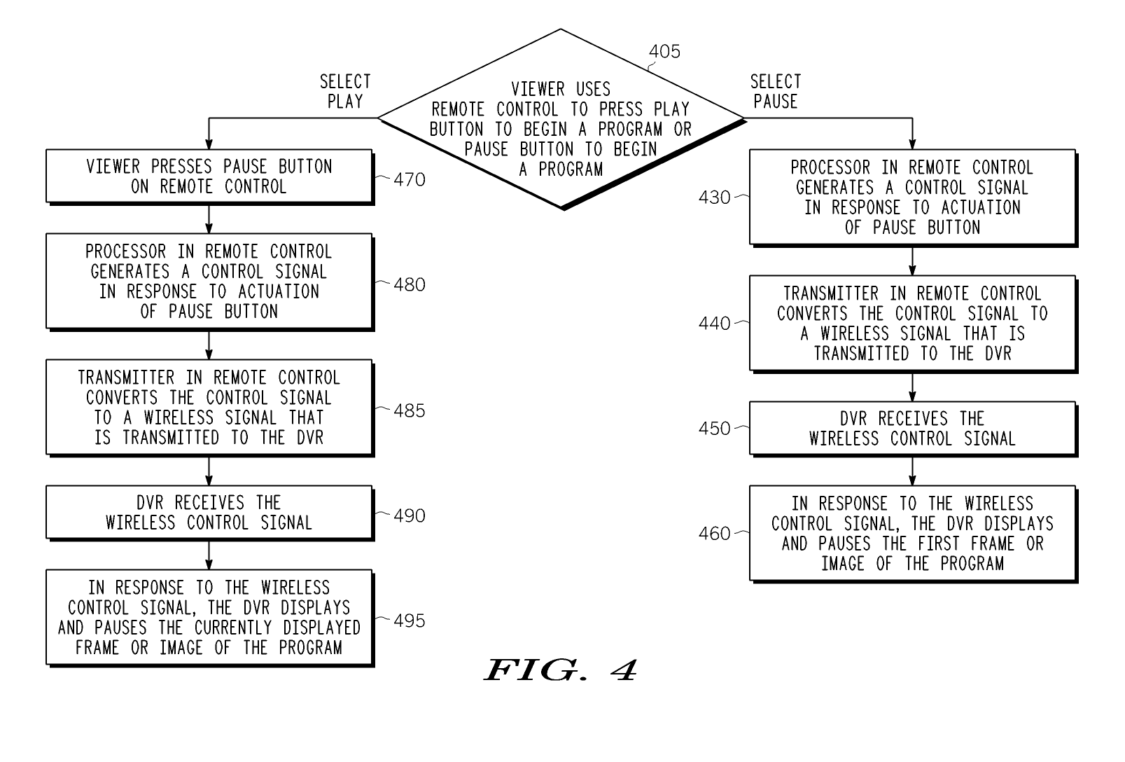

FIG. 4 is a flowchart illustrating one example of how the remote control described above can be used by a viewer to display and pause the first frame or image of a program that is stored on the storage medium of a DVR system. The method begins at decision step 405 when a viewer users the remote control unit to press the play button to begin a program or, alternatively, presses the pause button to begin a program. Next, assuming the viewer first presses the pause button to begin a program, in response thereto the processor located in the remote control generates a control signal (step 430) and the transmitter converts the control signal to a wireless signal that is transmitted to the DVR system (step 440). The DVR system receives the wireless control signal (step 450) and in response displays and pauses the first frame or image of the selected program on the display device (step 460).

If at decision step 405 the viewer uses the remote control unit to press the play button so that the selected program is in fact currently being played, the process continues with step 470, in which the viewer once again presses the pause button on the remote control unit. Steps 480, 485, 490 and 495 proceed similarly to steps 430, 440, 450 and 460 respectively, except that the control signal that is generated will now cause the DVR to display and pause the frame or image of the program that is currently being displayed.

Upon receipt of the control signal, the method illustrated in the flowchart of FIG. 4 may be implemented by any instructions stored in the DVR system 10, such as software 22. When loaded into a processor, such as processor 39, the software 22 operates to control the video signal and the establishment of a viewing session. As indicated above, however, it will be appreciated that aspects of the present invention are not limited to any specific embodiments of computer software or signal processing methods.

Although a specific architecture has been described herein, including specific functional elements and relationships, it is contemplated that the systems and methods herein may be implemented in a variety of ways. For example, functional elements may be packaged together or individually, or may be implemented by fewer, more or different devices, and may be either integrated within other products, or adapted to work with other products externally. When one element is indicated as being responsive to another element, the elements may be directly or indirectly coupled.

The process shown in FIG.4 may be implemented in a general, multi-purpose or single purpose processor. Such a processor will execute instructions, either at the assembly, compiled or machine-level, to perform that process. Those instructions can be written by one of ordinary skill in the art following the description of FIG. 4 and stored or transmitted on a computer readable medium. The instructions may also be created using source code or any other known computer-aided design tool. A computer readable medium may be any medium capable of carrying those instructions and include a CD-ROM, DVD, magnetic or other optical disc, tape, silicon memory (e.g., removable, non-removable, volatile or non-volatile), packetized or non-packetized wireline or wireless transmission signals.

It will furthermore be apparent that other and further forms of the invention, and embodiments other than the specific embodiments described above, may be devised without departing from the spirit and scope of the appended claims and their equivalents, and it is therefore intended that the scope of this invention will only be governed by the following claims and their equivalents.

1. A user interface for a video rendering device, comprising:
a plurality of user-actuatable inputs each having at least one prescribed function defining an operational mode of the video rendering device;
a processor, responsive to the plurality of user-actuatable inputs, for generating control signals that configure the video rendering device to operate in the operational modes defined by the respective user-actuable inputs; and
wherein a given one of said plurality of user-actuatable inputs has a prescribed function defining an operational mode of the video rendering device that displays and pauses a first frame or image of a program to be rendered by the video rendering device.

2. The user interface of claim 1 wherein the given user-actuatable input has a plurality of prescribed functions, a first of which pauses a currently displayed frame or image of a program as it is being rendered and a second which displays and pauses a first frame or image of the program when it is not being rendered.

3. The user interface of claim 1 further comprising a wireless transmitter for transmitting the control signals generated by the processor in a wireless manner to the video rendering device.

4. The user interface of claim 1 wherein the user-actuatable inputs are buttons located on a keypad.

5. The user interface of claim 1 wherein the user-actuatable inputs are displayed on a display device associated with the video rendering device.

6. The user interface of claim 1 wherein the video rendering device comprises a set-top terminal.

7. The user interface of claim 1 wherein the video rendering device comprises a DVR.

8. A method for rendering a frame or image of a selected video program to be rendered by a video rendering device, comprising:
receiving a single user command specifying an operational mode of a video rendering device that displays and pauses a first frame or image of the program; and
generating a control signal in response to the received user command; and
displaying and pausing the first frame or image of the program in response to the control signal.

9. The method of claim 8 further comprising transmitting the control signal from a remote control unit via which the single user command is received to the video rendering device.

10. The method of claim 9 wherein the control signal is a wireless control signal.

11. The method of claim 8 wherein the single user command is provided by a user-actuatable input has a plurality of prescribed functions, a first of which pauses a currently displayed frame or image of a program as it is being rendered and a second which displays and pauses a first frame or image of the program when it is not being rendered.

12. The method of claim 8 wherein the user command is received in response to a user selection presented on a display device.

13. A computer-readable storage medium having stored thereon one or more software programs which, when executed, implement the method of claim 8.

14. An apparatus for rendering a video program, comprising:
a computer-readable storage medium; and
a processor responsive to the computer-readable storage medium and to a software program, the software program, when loaded into the processor, operative to:
receive a single user command specifying an operational mode of a video rendering device that displays and pauses a first frame or image of a selected video program; and
generate a control signal in response to the received user command; and
display and pause the first frame or image of the program in response to the control signal.

15. The apparatus of claim 14 wherein the process is further operative to transmit the control signal from a remote control unit via which the single user command is received to the video rendering device.

16. The apparatus of claim 15 wherein the control signal is a wireless control signal.

17. The apparatus of claim 14 further comprising a user-actuatable input for providing the single user command, wherein the user-actuatable input has a plurality of prescribed functions, a first of which pauses a currently displayed frame or image of a program as it is being rendered and a second which displays and pauses a first frame or image of the program when it is not being rendered.
